(19) United States
(12) Patent Application Publication
(10) Pub. No.: US 2012/0207033 A1
(43) Pub. Date: Aug. 16, 2012

(54) Shared Band Deployment Support Function For Connection Establishment

(75) Inventors: Sami-Jukka Hakola, Kempele (FI); Timo K. Koskela, Oulu (FI); Samuli Turtinen, Ii (FI)

(73) Assignee: Renesas Mobile Corporation

(21) Appl. No.: 13/025,506

(22) Filed: Feb. 11, 2011

(51) Int. Cl. H04L 12/26

(52) U.S. Cl. 370/252

(57) ABSTRACT

A network support node collects information about unlicensed spectrum in use by a first access node; and provides at least some of the information to a user equipment via a second access node which utilizes licensed spectrum. In various exemplary embodiments: the information is collected via an interface between the first access node and the support node which does not pass through the second access node; the support node sends a query for the information when previously collected information is outdated; the support node sends to the first access node a preferred set of whitespace channels and/or virtual channelization; and the support node sends parameters for either/both access nodes to report on the unlicensed spectrum. Example parameters are: frequency/bandwidth range for the unlicensed spectrum in use by the first access node, and/or frequency range for a common control channel transmitted by the first access node in the unlicensed spectrum.

### TECHNICAL FIELD

The exemplary and non-limiting embodiments of this invention relate generally to wireless communication systems, methods, devices and computer programs and, more specifically, relate to collecting and distributing information about unlicensed spectrum currently in use, such as may be utilized for locating an access node suitable for offloading traffic from a cellular/licensed band network.

### BACKGROUND

The following abbreviations that may be found in the specification and/or the drawing figures are defined as follows:

3GPP third generation partnership project

AP access point

ANDSF access network discovery and selection function

eNB node B/base station in an E-UTRAN system

E-UTRAN evolved UTRAN (LTE)

ISM industrial, scientific and medical

LTE long term evolution

LTE-A long term evolution advanced

SBD-SN shared band device support node

UE user equipment

UTRAN universal terrestrial radio access network

TV WS television white spaces

WLAN wireless local area network

One approach to prevent congestion of cellular core networks due to the ever-increasing volume of wireless data and number of wireless users is to off-load some wireless traffic to non-cellular networks such as WLAN whose access points provide access to the Internet. Traffic off-load and anticipated gains from spectrum efficiency improvement is not expected to fully offset predicted data traffic increases, so in addition to the more costly licensed spectrum the discussion of utilizing unlicensed spectrum for wireless traffic is taking on more significance. Such unlicensed spectrum bands are also termed shared bands, and for example include the ISM band and the TV white spaces which the US Federal Communications Committee FCC is considering for this use.

In practice, such shared bands may be controlled by the licensed spectrum systems, or they may be used by a stand-alone cell such as a LTE-A femto cell which provides fast access to the Internet in a similar manner to the WLAN specifications at IEEE 802.11. The advantage of a LTE-A femto cell over traditional WLAN is the improved spectrum efficiency in LTE-A, realized through such concepts as LTE's flexibility in managing the deployment bandwidth, the number of utilized carriers, and even its flexible reconfiguration of center frequency.

Some discussion for developing the LTE-A standard for such shared band access may be seen at a presentation by M-A Phan, H. Wiemann and J. Sachs entitled FLEXIBLE SPECTRUM USAGE—HOW LTE CAN MEET FUTURE CAPACITY DEMANDS (Ericsson; Jul. 8, 2010;) and another by Rui Yang entitled OVERVIEW OF RESEARCH PROJECTS WITH NYU-POLY (InterDigital Communications; Nov. 12, 2010) [available as of Feb. 2, 2011 at http://www.ikr.uni-stuttgart.de/Content/itg/fg524/Meetings/2010-07-08-Heidelberg/03_ITG524_Heidelbera_Sachs.pdf and http://catt.poly.edu/content/researchreview10/OverviewOffResearchProjectswithNYU-Poly.pdf, respectively).

One challenge in adopting this shared band concept is to manage the increased discovery burden on mobile devices. Since the interference situation can dynamically change, the access node (eNB in LTE-A) has to be able to avoid the primary users (e.g., on TV white spaces) and crowded channels. But for the mobile devices the avoidance and re-deployment to find suitable channels may cause extra effort in its access node discovery phase. Blind searching by mobile devices across all the possible channels (e.g., TV white spaces, ISM 2.4 Ghz, ISM 5 GHz, etc.) may be too exhaustive given the mobile devices' limited portable power supply.

Additionally, it is reasonable that future cellular operation on these shared bands such as ISM should be agile enough to quickly react to that changing interference environment. FIG. 1 illustrates some drivers for such agility. Panel A represents a fast asymmetric bandwidth reduction, in which a section of the shared band outboard of the center frequency becomes occupied by primary users or otherwise crowded and no longer is available for additional unlicensed users. Panel B represents a relatively fast movement of resources carrying common control channels from near the center frequency to being offset therefrom. Panel C represents shifting the deployment bandwidth on a spectrum by some amount while still remaining on the same band, which may result from the same conditions as in panel A but at panel C the result is a combination of panels A and the center frequency shift of B. Thus, for new devices it may be a high burden to find certain systems utilizing shifting portions the unlicensed spectrum with only blind detection across all known unlicensed bands.

Release 8 of the LTE system specifies an entity termed an Access Network Discovery and Selection Function (ANDSF) to aid the UE in network selection. ANDSF is a layer 3 protocol which allows operators to provide inter-system mobility policies. Being layer 3, interface between the UE and the ANDSF without intervention by the eNB is a possibility. A properly configured ANDSF should enable devices to select the most suitable access network of different access network technologies (e.g. WLAN or WiMAX) that are available in the area. The selection is enabled by exchanging information between the device and ANDSF server. According to 3GPP TS 23.402 V10.2.1 (2011 January), the ANDSF is discovered through interaction with the Domain Name Service DNS function or the Dynamic Host Configuration Protocol DHCP Server function. 3GPP TS 24.302 further provides that the domain name or the IP address of the ANDSF can also be discovered by the UE by means of the DHCP query.

However, ANDSF is in an initial stage of standardization and currently the specifics for its interfacing with the mobile device and also its internal workings are not yet fully defined. The ANDSF has no connections to other entities in the network and it relies only on its own information for the selection decisions. Currently the ANDSF functionalities and interfaces are not suitable for supporting efficient utilization of the unlicensed spectrum. The teachings below address this shortfall and others.

### SUMMARY

In a first exemplary embodiment of the invention there is an apparatus comprising at least one processor and at least one memory storing a computer program. In this embodiment the at least one memory with the computer program is configured with the at least one processor to cause the apparatus to at least: collect at a network support node information about unlicensed spectrum in use by a first access node; and provide at least some of the information to a user equipment via a second access node which utilizes licensed spectrum.

In a second exemplary embodiment of the invention there is a method comprising: collecting information about unlicensed spectrum in use by a first access node; and providing at least some of the information to a user equipment via a second access node which utilizes licensed spectrum.

In a third exemplary embodiment of the invention there is a computer readable memory storing a computer program, in which the computer program comprises: code for collecting information about unlicensed spectrum in use by a first access node; and code for providing at least some of the information to a user equipment via a second access node which utilizes licensed spectrum.

In a fourth exemplary embodiment of the invention there is an apparatus comprising at least one processor and at least one memory storing a computer program. In this embodiment the at least one memory with the computer program is configured with the at least one processor to cause the apparatus to at least: establish a wireless connection with a first access node utilizing unlicensed spectrum; and utilize the wireless connection and the first access node to obtain from a network support node information about unlicensed spectrum in use by at least one other access node different from the first access node.

In a fifth exemplary embodiment of the invention there is a method comprising: establishing a wireless connection with a first access node utilizing unlicensed spectrum; and utilizing the wireless connection and the first access node to obtain from a network support node information about unlicensed spectrum in use by at least one other access node different from the first access node.

In a sixth exemplary embodiment of the invention there is a computer readable memory storing a computer program, in which the computer program comprises: code for establishing a wireless connection with a first access node utilizing unlicensed spectrum; and code for utilizing the wireless connection and the first access node to obtain from a network support node information about unlicensed spectrum in use by at least one other access node different from the first access node.

These and other embodiments and aspects are detailed below with particularity.

### BRIEF DESCRIPTION OF THE DRAWINGS

FIG. 1 is an illustration of three distinct ways in which the portion of unlicensed spectrum/shared bands in use by a femto eNB or similar might be dynamically changed.

FIG. 2 is a schematic diagram illustrating an environment in which embodiments of the invention may be practiced to advantage.

FIG. 3 is a logic flow diagram that illustrates the operation of a method, and a result of execution of computer program instructions embodied on a computer readable memory, in accordance with the exemplary embodiments of this invention.

FIG. 4 is a frequency plot showing virtual channel deployment over multiple ‘existing’ channels as may be utilized by exemplary embodiments of the invention.

FIG. 5 is a logic flow diagram that illustrates the operation of a method, and a result of execution of computer program instructions embodied on a computer readable memory, in accordance with the exemplary embodiments of this invention.

FIG. 6 is a simplified block diagram of the UE which obtains information for discovering and connecting with a femto eNB by obtaining radio resource information of a shared band via a support node and a macro access node/macro eNB, and shows exemplary electronic devices suitable for use in practicing the exemplary embodiments of the invention.

### DETAILED DESCRIPTION

The ANDSF contains data management and control functionality necessary for providing network discovery and selection assistance data to the UE according to the operators' policy. The ANDSF is able to initiate data transfer to the UE based on network triggers, and respond to requests from the UE. The ANDSF is located in the subscriber's home operator network and the information to access it should be either configured on the UE or discovered by other means. There are push mechanisms which enable the ANDSF to provide assistance information at any time to the UE, and also pull mechanisms which provide the UE with the capability to send a request to the ANDSF in order to obtain assistance information for access network discovery and selection.

Embodiments of these teachings provide an entity, which in the examples below is a shared band device support node SBD-SN that may be implemented as an extension of the current ANDSF, which is adapted to provide dynamic access network map generation as to what kind of access networks are in the vicinity of mobile devices, thereby enabling offload of traffic to/from those mobile devices from the macro (cellular) system to the unlicensed shared bands in use by femto eNBs. While the examples below use the term macro and femto eNBs, these teachings are not limited to only those access nodes and other access node embodiments are readily substituted.

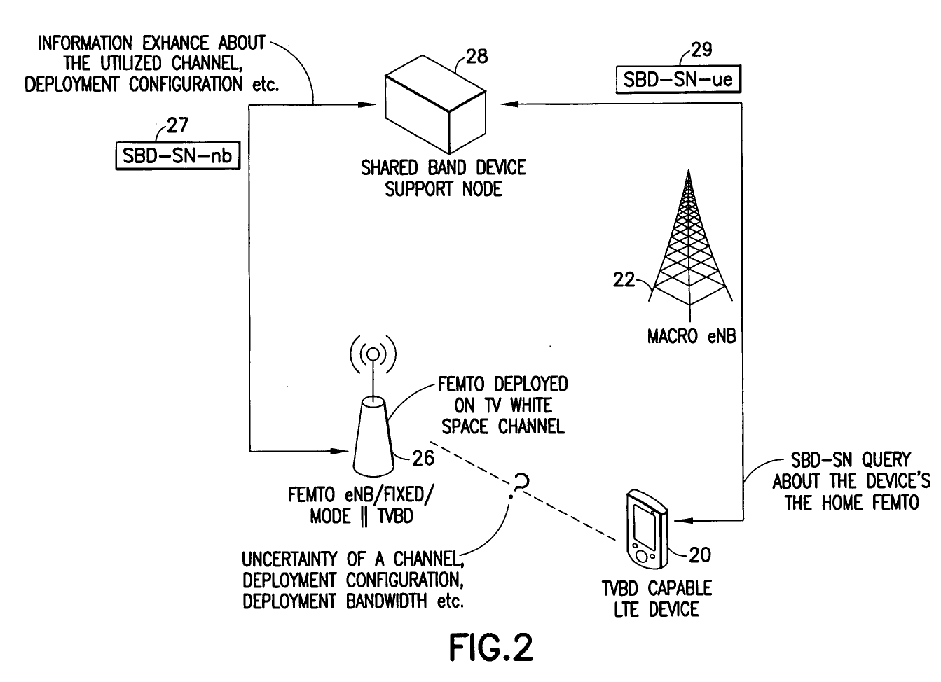

FIG. 2 illustrates an environment in which embodiments of these teachings may be practiced to advantage. There is a mobile device/UE 20 which is capable of operating in the unlicensed/shared bands and which is in the vicinity of both a macro (traditional cellular) eNB 22 and a femto eNB 26. Conventionally, the ANDSF is only available to the UE 20 via layer 3 signaling, and only discoverable via the DNS or DHCP server protocols. While there are established methods for the UE 20 to discover and attach to the macro eNB 22, such as via a random access channel procedure in the LTE system, simply extending analogous procedures for the UE 20 to discover any femto eNBs 26 is too high of a blind detection burden given the scope of what spectrum might be in use as shared bands at any given time.

To that end the SBD-SN is adapted to have interfaces SBD-SN-ue 29 and/or SBD-SN-nb 27 with the respective macro eNB 22 and/or femto eNB 26 for data exchange as will be detailed below. This facilitates a more efficient utilization of the unlicensed spectrum between the femto eNB 26 and the UE 20. In an embodiment the SBD-SN 28 for the particular UE 20 is disposed within the UE's home network, and the interfaces 27, 29 pass through one or more core and operating networks for the case in which the macro eNB 22 and the femto eNB 26 lie within a network which from the UE's perspective is a visited network. In another embodiment in the below examples, the SBD-SN 28 for the particular UE 20 is disposed within the operating network which comprises the macro eNB to which the UE is attached, and so if the UE is attached to a visited network the SBD-SN is also in that same visited network.

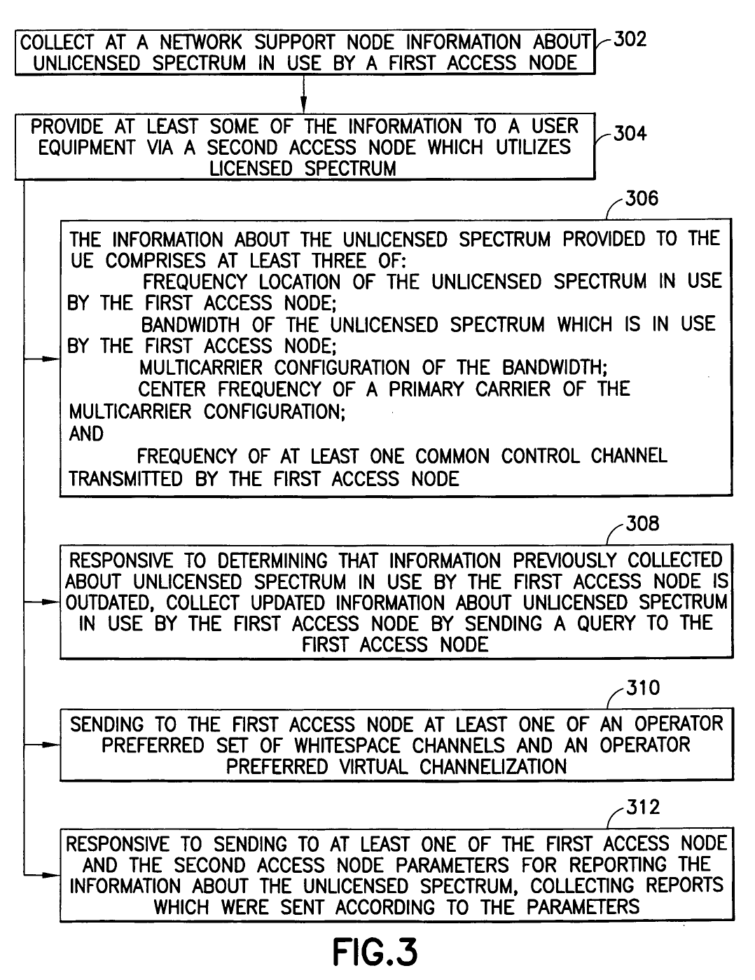

The description below references FIGS. 2-3. Exemplary embodiments of these teachings provide a SBD-SN 28 which at block 302 collects information about unlicensed spectrum in use by a first access node, and at block 304 provides at least some of the information to a UE via a second access node which utilizes licensed spectrum. With respect to FIG. 2 the first access node is the femto eNB 26 which uses the unlicensed spectrum, the second node is the macro eNB 22 which uses licensed spectrum, and the information about the unlicensed spectrum is collected at the SBD-SN 28 via a SBD-SN-nb interface 27 between the femto eNB 26 and the SBD-SN 28 which does not pass through the macro eNB 22.

In this embodiment this new interface 27 between the femto eNB 26 operating on unlicensed spectrum and the SBD-SN 28 provides architectural support for the embodiments below. By example the SBD-SN 28 can be an extension element of the ANDSF.

In the conventional ANDSF the network operator can store information about WLAN access points under the network operator's own control. In an exemplary embodiment of this invention the LTE system (shown at FIG. 2 as the macro eNB 22 and the femto eNB 26) operating on the shared band registers itself into the ANDSF (or the SBD-SN within the ANDSF) and informs the ANDSF/SBD-SN about critical information about the radio resources within the unlicensed/shared band which is currently in use. Thus the stored information is an operator specific database where the femto eNB 26 can inform for example its current location, bandwidth, multicarrier configuration, primary carrier center frequency, etc., in order to make discovery of that femto eNB 26 by a UE 20 easier and require less blind detection than if the UE did not have this radio resource information.

As shown at block 306, the SBD-SN provides this information about the unlicensed spectrum to the UE as any one or more of: frequency location of the unlicensed spectrum in use by the first access node; bandwidth of the unlicensed spectrum which is in use by the first access node; multicarrier configuration of the bandwidth; center frequency of a primary carrier of the multicarrier configuration; and frequency of at least one common control channel transmitted by the first access node.

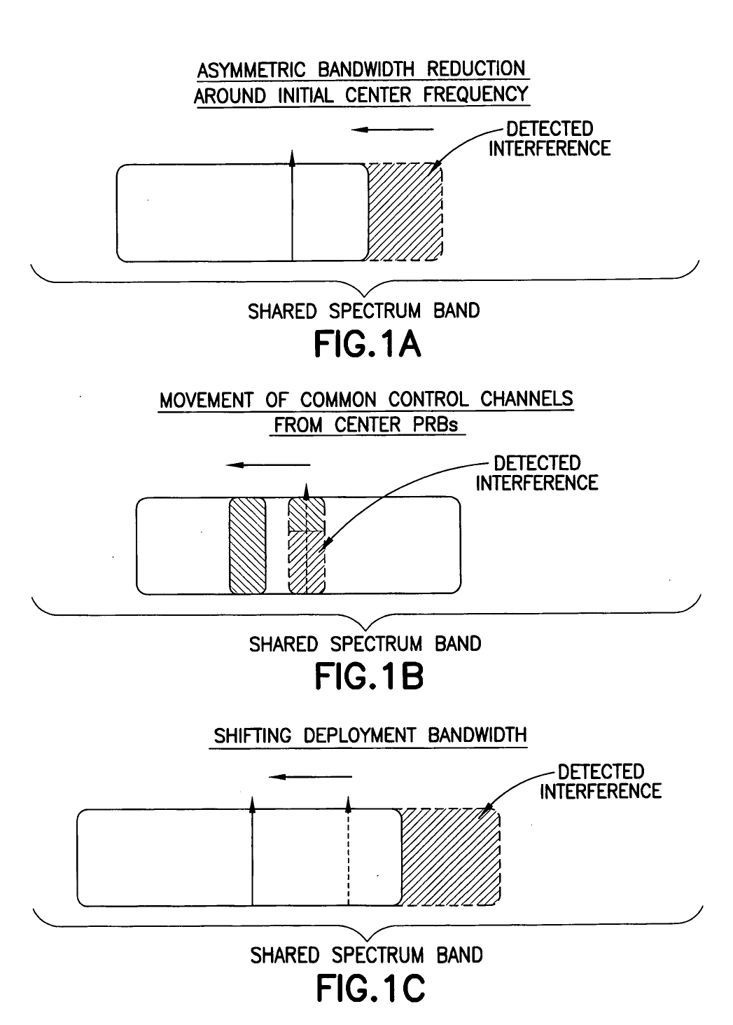

As noted with respect to FIG. 1, usage on the unlicensed spectrum changes dynamically, and so in an embodiment if the femto eNB has not reported information to the database, or the information is outdated, the SBD-SN initiates a pull-mode operation to update it by sending a query for the femto eNB's current configuration and location of its current radio resource usage in the spectrum.

This embodiment is shown at block 308 of FIG. 3, in which from the SBD-SN's perspective the SBD-SN determines that information previously collected about unlicensed spectrum in use by the femto eNB 26 is outdated, and responsive to that determination the SBD-SN 28 collects updated information about unlicensed spectrum in use by the femto eNB by sending a query to it over the interface 27.

In another embodiment the UE 20 can connect to the database within the SBD-SN 28 via a connection over licensed spectrum (e.g., via the macro eNB 22) to obtain information about the preferred femto eNB. This embodiment uses the SBD-SN-ue interface 29 shown at FIG. 2. This is similar to the conventional ANDSF which has some information about its own femto eNBs, but in this embodiment as noted above the information is more specific to make femto eNB discovery easier, such as indications of the current primary center frequency (or a certain frequency area where common control channels are transmitted), deployment information (e.g., bandwidth of the used unlicensed spectrum, its multi carrier configuration, etc.). Since as noted above this information changes dynamically, it is available to the UE 20 via the macro side interface 29 to prevent the UE 20 from having to undertake an extensive side scanning of local eNBs.

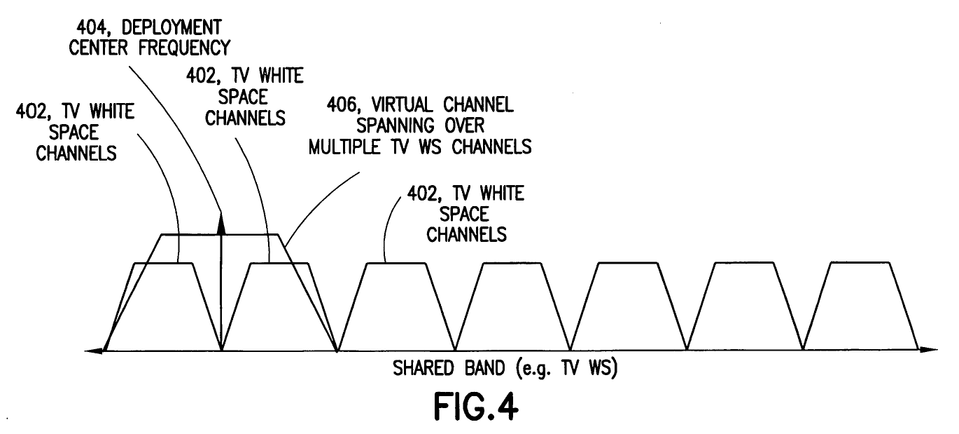

In another exemplary embodiment, the network operator can, via the SBD-SN 28, configure the femto eNB 26 via the SBD-SN-nb interface 29 to select a certain operator-preferred set or subset of TV white space channels, or the operator-preferred virtual channelization of another shared band such as ISM. This is detailed below with respect to FIG. 4, and further enhances the UE's discovery of the femto eNB 26 and deployment of the femto eNB 26 itself. For example, the 2.4 GHz ISM band has an available spectrum of 100 MHz, and so one of the well-known configurations of that ISM band is the WLAN channelization. But the LTE has more flexible options to deploy 100 MHz or portions thereof, and so the network operators can exploit this embodiment to set their preferences on how best to exploit whatever bandwidth of that whole spectrum is available for use by the femto eNB 26.

Block 310 of FIG. 3 illustrates this embodiment in that the SBD-SN 28 sends to the femto eNB 26 at least one of an operator preferred set of whitespace channels and an operator preferred virtual channelization.

In another exemplary embodiment there is associated signaling by which the macro eNB 28 stores in its memory the above-detailed information on the femto eNB's current usage of the unlicensed spectrum, which the macro eNB 22 fetches from the SBD-SN 28. Similarly there is also signaling by which the UE 20 stores in its memory the information about unlicensed spectrum in use by the femto eNB 26 which it fetches from the SBD-SN via the licensed bands and the macro eNB 22. The SBD-SN builds its database from various femto eNBs 26 and stores that database in its own local memory for fetching by the macro eNB 22 and the UE 20.

In a more particular exemplary embodiment the configuration and information exchange among the LTE system (eNBs 22, 26) operating on the shared band and the new logical network element implemented as the SBD-SN 28 (e.g., an ANDSF extension) may be considered as a two-stage process as detailed at block 312 of FIG. 3.

At a first (macro) stage, the LTE system is configured, or even just one femto eNB on the shared band is configured by the SBD-SN 28 to provide high-level spectrum portions in which to operate. In the configuration, the LTE system receives parameters to control the update reporting to the SBD-SN 28 by the wireless system which is done in the second or micro stage. Block 312 recites this as the SBD-SN 28 sending to at least one of the first access node/femto eNB 26 and the second access node/macro eNB 22 parameters for reporting the information about the unlicensed spectrum in use by the first access node/femto eNB 26.

The second (micro) stage is more concerned with actions by the wireless network itself on the shared band, along with signaling to the SBD-SN. Block 312 describes this from the SBD-SN 28 perspective as collecting reports which were sent according to the parameters.

More particularly, within the given spectrum portion, the system (femto eNB or macro eNB) finds and selects suitable radio resources for its operation. Once those radio resources have been selected, the LTE system may inform the SBD-SN 28 about the selected resources, or the LTE system may simply register itself as a user of the certain spectrum portion.

The parameters themselves may in another embodiment be sent in the second/micro stage, but in any case the parameters define the trigger(s) for the LTE network (femto or macro eNB) to send an update report to the SBD-SN to inform it of the current radio resource information in use for the unlicensed spectrum/shared band. By example, the parameters may include a frequency pair which give a range that when the wireless system is no longer operating entirely inside (concerning the shared band) the macro eNB 22 or femto eNB 26 (depending on the embodiment) is required to inform the SBD-SN of the new radio resource information in use. In another example the frequency pair defines a bandwidth range, and when the wireless system reduces or increases the bandwidth is smaller (or larger, depending on implementation) then the bandwidth defined by the range the wireless network must send a report informing the SBD-SN of the new radio resource information. In a still further example the frequency pair defines a common control channel range, and the wireless network must inform the SBD-SN of the new radio resource information if it changes its transmissions of common control channels to be outside that range. These are exemplary but non-limiting embodiments of radio resource usage parameters for triggering an update report concerning the shared band in use.

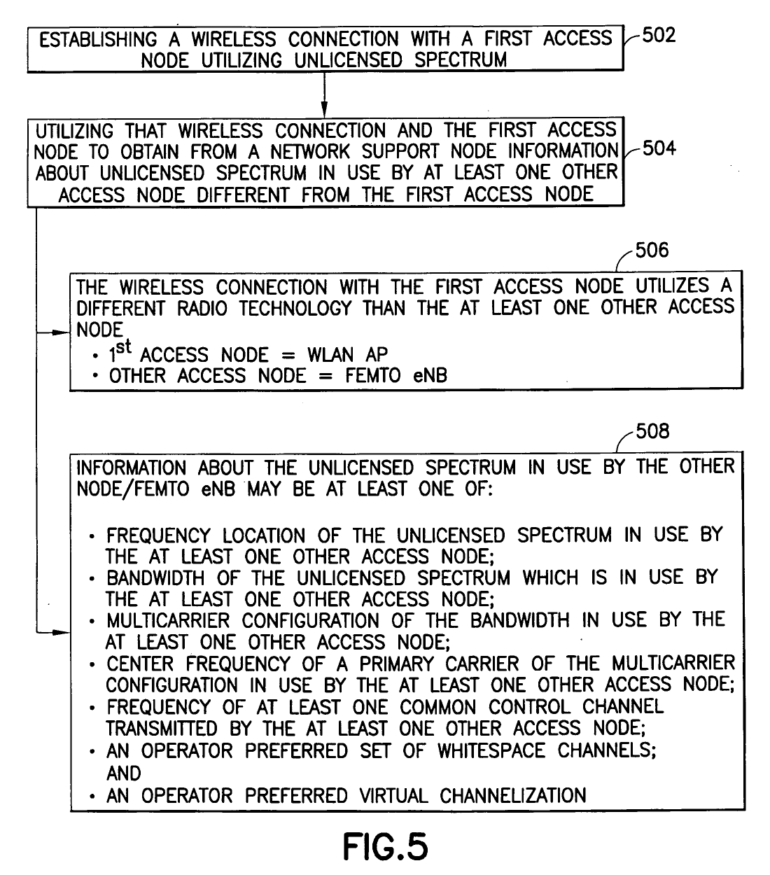

FIG. 3 above is a logic flow diagram which describes an exemplary embodiment of the invention in a manner which may be from the perspective of the SBD-SN 28. FIG. 5 below is a logic flow diagram which describes an exemplary embodiment of the invention in a manner which may be from the perspective of the UE 20. FIGS. 3 and/or 5 may be considered to illustrate the operation of a method, and a result of execution of a computer program stored in a computer readable memory, and a specific manner in which components of an electronic device are configured to cause that electronic device to operate. The various blocks shown in FIGS. 3 and 5 may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Now is described the virtual channelization which was mentioned above, with reference to FIG. 4 and using TV white spaces as the example shared band though virtual channelization may be utilized on essentially any shared band. Assume for example that the macro eNB operator wants to offload traffic to the ISM band. For offloading purposes it utilizes a femto eNB deployment but may want to deploy the femto eNBs at certain frequency ranges on the ISM band, and/or the macro cell operator may choose to avoid WLAN channelization for that white space shared band for improved efficiency. For the UE, in order to find the different femto eNBs in the shared band, in some conventional cases an extensive scanning might have to be carried out to find the specific femto eNBs. When considering the virtual channelization (the center frequency around which in LTE the common control channels are mapped) the task may become overly time consuming due to blind scanning.

At FIG. 4 the whole shared band is shown with the TV white spaces 402 lying within the first three bands of the whole shared band. The macro eNB 22 chooses to deploy the femto eNB 26 only on the first two bands of that white space 402 and the center frequency 404 of that deployment is shown. In this case the virtual channel 406 spans over multiple TV white space bands, and so by the femto eNB's 26 report to the SBD-SN 28 of the center frequency 404 and/or frequency range of the virtual channel 406 that femto eNB 26 is using, or other such relevant radio resource information as is detailed more particularly above, the UE 20 can learn via signaling through the macro eNB 22 where to begin looking for the femto eNB's common control channels so it can attach and offload its traffic from the macro eNB 22 to the femto eNB 26.

So in summary and with reference to the environment and nodes shown at FIG. 2, the femto eNB 26 is deployed to the shared band (TV white spaces for example), but due to the nature of shared bands/unlicensed spectrum different channels or portions of the unlicensed spectrum may be occupied at any time by other users, effectively leading to dynamically changing interference situations and the need for the macro eNB 22 or femto eNB 26 (depending upon how much autonomy the femto eNB 226 is given) to re-select/re-evaluate the channel(s) in the unlicensed band which are to be in use. The radio resource information which helps the UE 20 find the femto eNB 26 is passed through two interfaces to the SBD-SN 28: the SBD-SN-nb interface 27 between the femto eNB 26 and the SBD-SN 28; and the SBD-SN-ue interface 29 between the UE 20 (via the macro eNB 22) and the SBD-SN 28.

The SBD-SN 28 itself resides in the operator network. This entity is in one embodiment a logical entity such as for example an ANDSF extension to support the shared band operation. In another embodiment this entity is a stand-alone server as shown at FIG. 2. Due to the flexible deployment possibilities of LTE and LTE-A systems, the femto eNB 26 may have several downlink carriers to occupy non-adjacent TV white space channels, or it may span the deployment bandwidth over multiple adjacent TV white space channels. Also, spanning the carrier over multiple TV white space channels (e.g., 6 MHz or 8 MHZ) may cause the center frequency to be ‘off-channel’, as shown at FIG. 4. In addition virtual channelization on the shared band may cause some uncertainty of the deployment if a priori information is available for the user devices of how that virtual channelization is designed.

FIG. 5 is a logic flow diagram that illustrates from the perspective of a user equipment 20 the operation of a method, and a result of execution of computer program instructions embodied on a computer readable memory, in accordance with the exemplary embodiments of this invention. In this embodiment the UE 20 gains access to the SBD-SN 28 via the unlicensed band and the SBD-SN-nb interface 27. By example, this embodiment is advantageous for the non-limiting example in which the UE 20 is in contact with a WLAN access node via the unlicensed band and accesses the SBD-SN 28 to learn information for contacting other nodes utilizing unlicensed bands, such as for example non-WLAN femto eNBs which may not be so easy for the UE 20 to find.

Block 502 begins with the UE/apparatus establishing a wireless connection with a first access node utilizing unlicensed spectrum. The UE utilizes that wireless connection and the first access node at block 504 to obtain from a network support node (e.g., the SBD-SN 28 over the SBD-SN-nb interface 27) information about unlicensed spectrum in use by at least one other access node different from the first access node.

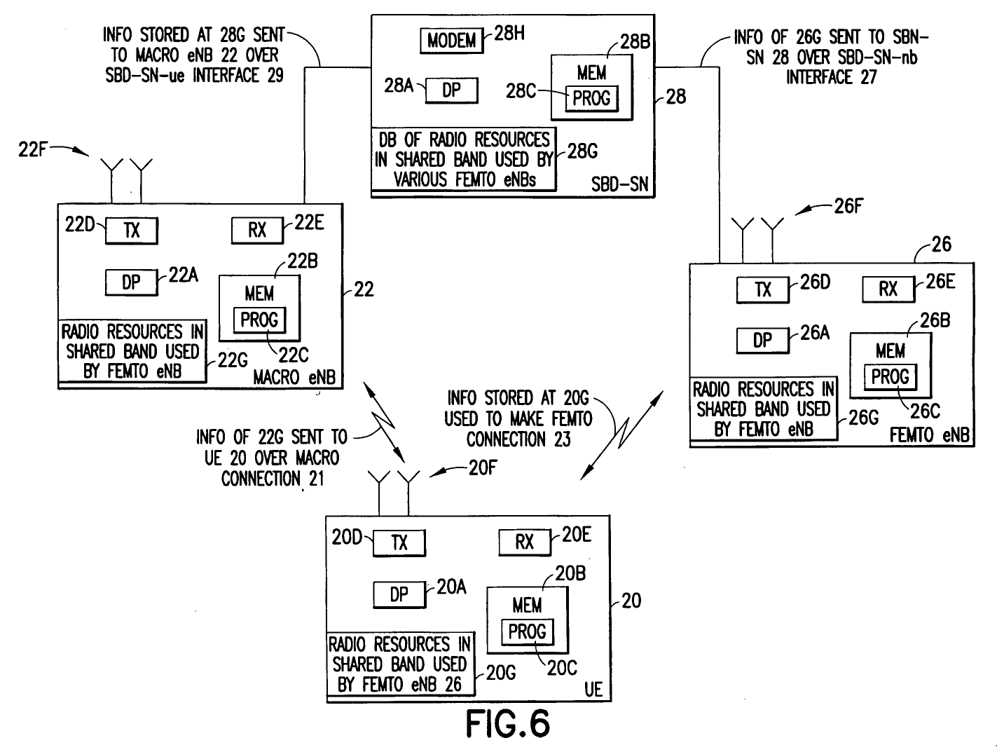

Advantages of this aspect of the invention are particularly evident for the case in which the wireless connection with the first access node utilizes a different radio technology than the at least one other access node as set forth at block 506, which gives also the specific but non-limiting example in which the first access node is a WLAN access point utilizing WLAN radio access technology and the at least one other access node comprises a femto eNB utilizing E-UTRAN/LTE radio access technology (in the unlicensed band). In this case, the WLAN access point would be in the position of the femto eNB 26 illustrated at FIG. 6 (detailed below) and the UE 20 would use the information about the unlicensed spectrum in use by some further femto eNB, which the UE 20 obtains from its unlicensed-band connection with the WLAN, to establish a wireless connection with that further femto eNB which is not shown at FIG. 6. By example the unlicensed spectrum in use by the at least one other access node/femto eNB comprises TV white spaces or ISM band.

Block 508 indicates that the information about the unlicensed spectrum in use by the other node/femto eNB may be at least one of:
frequency location of the unlicensed spectrum in use by the at least one other access node;
bandwidth of the unlicensed spectrum which is in use by the at least one other access node;
multicarrier configuration of the bandwidth in use by the at least one other access node;
center frequency of a primary carrier of the multicarrier configuration in use by the at least one other access node;
frequency of at least one common control channel transmitted by the at least one other access node;
an operator preferred set of whitespace channels; and
an operator preferred virtual channelization.

Exemplary embodiments of these teachings provide the technical effect of providing support of shared band deployments and operator traffic offloading, and further to mitigate extensive scanning over the shared bands by the UE 20 to obtain knowledge about the shared band which is in use by the femto access node. For the UE-specific aspects detailed with respect to FIG. 5, there may or may not be traffic offloading since the UE may have no current connection over licensed spectrum (only connected via the WLAN for example). But if there is no traffic offloading there is still the technical effect of enabling the UE to obtain information via one access node about unlicensed band(s) in use by another access node, particularly utilizing a different radio access technology, without necessarily having to utilize any licensed band at all.

Reference is now made to FIG. 6 for illustrating a simplified block diagram of various electronic devices and apparatus that are suitable for use in practicing the exemplary embodiments of this invention. In FIG. 6 a macro eNB 22 is adapted for communication over a macro wireless link 21 with an apparatus, such as a mobile terminal or UE 20. The macro eNB may be any access node (including relay nodes) of any wireless network using licensed bands, such as LTE, LTE-A, GSM, GERAN, WCDMA, and the like. The operator network of which the macro eNB 22 is a part may also include a network control element (not shown, such as a MME/SGW or RNC) which provides connectivity with further networks (e.g., a publicly switched telephone network PSTN and/or a data communications network/Internet). Also within the operator network is the SBD-SN 28 and the femto eNB 26.

The UE 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the eNB 22 via one or more antennas 20F. Also stored in the MEM 20B at reference number 20G is the information about the radio resources in use by the femto eNB 26 in the shared/unlicensed band, which the UE 20 obtains from the macro eNB 22 over the macro link 21 as detailed in the examples above.

The macro eNB 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the UE 20 via one or more antennas 22F. There is a data and/or control path, termed herein as the SBD-SN-ue interface 29, coupling the macro eNB 22 with the SBD-SN 28 and over which the macro eNB 22 receives the information about the radio resources in use by the femto eNB 28 in the shared/unlicensed bands. The macro eNB 22 stores this critical radio resource deployment information 22G in its local MEM 22B after receipt from the SBD-SN 28 as detailed in the examples above.

Similarly, the SBD-SN 28 includes processing means such as at least one data processor (DP) 28A, storing means such as at least one computer-readable memory (MEM) 28B storing at least one computer program (PROG) 28C, and communicating means such as a modem 28H for bidirectional wireless communications with the macro eNB 22 via the interface 29 and also with the femto eNB 26 over the other interface 27. While not particularly illustrated for the UE 20 or macro eNB 22 or femto eNB 26, those devices are also assumed to include as part of their wireless communicating means a modem which may be inbuilt on an RF front end chip within those devices 20, 22, 26 and which also carries the TX 20D/22D/26D and the RX 20E/22E/26E.

The femto eNB 26 includes its own processing means such as at least one data processor (DP) 26A, storing means such as at least one computer-readable memory (MEM) 26B storing at least one computer program (PROG) 26C, and communicating means such as a transmitter TX 26D and a receiver RX 26E for bidirectional wireless communications with the UE 20 via one or more antennas 26F. There is a data and/or control path, termed herein as the SBD-SN-nb interface 27, coupling the femto eNB 26 with the SBD-SN 28 and over which the femto eNB 26 send the information about the radio resources it is using in the shared/unlicensed bands. The femto eNB 26 stores this critical radio resource deployment information 26G in its local MEM 26B along with the reporting parameters it received from the SBD-SN 28 as detailed in the examples above.

At least one of the PROGs 20C in the UE 20 is assumed to include program instructions that, when executed by the associated DP 20A, enable the device to operate in accordance with the exemplary embodiments of this invention, as detailed above. The macro eNB 22 and femto eNB 26 and SBD-SN 28 also have software stored in their respective MEMs to implement certain aspects of these teachings. In these regards the exemplary embodiments of this invention may be implemented at least in part by computer software stored on the MEM 20B, 22B, 26B, 28B which is executable by the DP 20A of the UE 20 and/or by the DP 22A/26A/28A of the respective macro eNB 22/femto eNB 26/SBD-SN 28, or by hardware, or by a combination of tangibly stored software and hardware (and tangibly stored firmware). Electronic devices implementing these aspects of the invention need not be the entire devices as depicted at FIG. 2 or 6, but exemplary embodiments may be implemented by one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 20B, 22B, 26B and 28B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A, 26A and 28A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the E-UTRAN system, as noted above the exemplary embodiments of this invention are not limited for use with only this one particular type of wireless communication system.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus, comprising:
at least one processor; and
at least one memory storing a computer program;
in which the at least one memory with the computer program is configured with the at least one processor to cause the apparatus to at least:
collect at a network support node information about unlicensed spectrum in use by a first access node; and
provide at least some of the information to a user equipment via a second access node which utilizes licensed spectrum.

2. The apparatus according to claim 1, in which the at least one memory with the computer program is configured with the at least one processor to cause the apparatus to collect the information about the unlicensed spectrum in use by the first access node via an interface between the first access node and the network support node which does not pass through the second access node.

3. The apparatus according to claim 1, in which the information about the unlicensed spectrum provided to the user equipment comprises at least three of:
frequency location of the unlicensed spectrum in use by the first access node;
bandwidth of the unlicensed spectrum which is in use by the first access node;
multicarrier configuration of the bandwidth;
center frequency of a primary carrier of the multicarrier configuration; and
frequency of at least one common control channel transmitted by the first access node.

4. The apparatus according to claim 1, in which the at least one memory with the computer program is configured with the at least one processor to cause the apparatus to, upon determining that information previously collected about unlicensed spectrum in use by the first access node is outdated, to collect updated information about unlicensed spectrum in use by the first access node by sending a query to the first access node.

5. The apparatus according to claim 1, in which the at least one memory with the computer program is configured with the at least one processor to cause the apparatus to at least:
send to the first access node at least one of an operator preferred set of whitespace channels and an operator preferred virtual channelization.

6. The apparatus according to claim 1, in which the at least one memory with the computer program is configured with the at least one processor to cause the apparatus to collect at the network support node the information about the unlicensed spectrum by sending to at least one of the first access node and the second access node parameters for reporting to the network support node the information about the unlicensed spectrum and collecting reports sent to the network support node according to the parameters.

7. The apparatus according to claim 6, in which the collected reports comprise at least one of: identification of selected radio resources within the unlicensed spectrum which are in use by the first access node; and registration of the first or second access node as a user of the selected radio resources.

8. The apparatus according to claim 6, in which the parameters for reporting comprise at least one of:
frequency range for the unlicensed spectrum in use by the first access node;
bandwidth range for the unlicensed spectrum in use by the first access node; and
frequency range for at least one common control channel transmitted by the first access node in the unlicensed spectrum.

9. The apparatus according to claim 1, in which the apparatus comprises the network support node; the first access node comprises a femto eNB; and the second access node comprises a cellular eNB.

10. A method, comprising:
collecting information about unlicensed spectrum in use by a first access node; and
providing at least some of the information to a user equipment via a second access node which utilizes licensed spectrum.

11. The method according to claim 10, in which the method is executed by a network support node, and the information about the unlicensed spectrum in use by the first access node is collected via an interface between the first access node and the network support node which does not pass through the second access node.

12. The method according to claim 10, in which the information about the unlicensed spectrum provided to the user equipment comprises at least three of:
frequency location of the unlicensed spectrum in use by the first access node;
bandwidth of the unlicensed spectrum which is in use by the first access node;
multicarrier configuration of the bandwidth;
center frequency of a primary carrier of the multicarrier configuration; and
frequency of at least one common control channel transmitted by the first access node.

13. The method according to claim 10, in which collecting the information comprises:
responsive to determining that information previously collected about unlicensed spectrum in use by the first access node is outdated, collecting updated information about unlicensed spectrum in use by the first access node by sending a query to the first access node.

14. The method according to claim 10, the method further comprising:
sending to the first access node at least one of an operator preferred set of whitespace channels and an operator preferred virtual channelization.

15. The method according to claim 10, in which collecting the information comprises:
responsive to sending to at least one of the first access node and the second access node parameters for reporting the information about the unlicensed spectrum, collecting reports which were sent according to the parameters.

16. The method according to claim 15, in which the collected reports comprise at least one of: identification of selected radio resources within the unlicensed spectrum which are in use by the first access node; and registration of the first or second access node as a user of the selected radio resources.

17. The method according to claim 15, in which the parameters for reporting comprise at least one of:
frequency range for the unlicensed spectrum in use by the first access node;
bandwidth range for the unlicensed spectrum in use by the first access node; and
frequency range for at least one common control channel transmitted by the first access node in the unlicensed spectrum.

18. A computer readable memory storing a computer program comprising:
code for collecting information about unlicensed spectrum in use by a first access node; and
code for providing at least some of the information to a user equipment via a second access node which utilizes licensed spectrum.

19. The computer readable memory according to claim 18, in which:
the memory is disposed within a network support node;
the information about the unlicensed spectrum in use by the first access node is collected via an interface between the first access node and the network support node which does not pass through the second access node; and
the information about the unlicensed spectrum provided to the user equipment comprises at least three of:
frequency location of the unlicensed spectrum in use by the first access node;
bandwidth of the unlicensed spectrum which is in use by the first access node;
multicarrier configuration of the bandwidth;
center frequency of a primary carrier of the multicarrier configuration; and
frequency of at least one common control channel transmitted by the first access node.

20. The computer readable memory according to claim 18, in which the code for collecting the information comprises:
code, responsive to determining that information previously collected about unlicensed spectrum in use by the first access node is outdated, for collecting updated information about unlicensed spectrum in use by the first access node by sending a query to the first access node.

21.-42. (canceled)
